(19) United States
(12) Patent Application Publication
(10) Pub. No.: US 2009/0237355 A1
(43) Pub. Date: Sep. 24, 2009

(54) HEAD TRACKING FOR VIRTUAL REALITY DISPLAYS

(76) Inventors: Storm Orion, Pittsburgh, PA (US); David Hochendoner, Allison Park, PA (US)

Correspondence Address: BUCHANAN INGERSOLL & ROONEY PC, P.O. BOX 1404, ALEXANDRIA, VA, 22313-1404, US

(21) Appl. No.: 12/409,912

(22) Filed: Mar. 24, 2009

Related U.S. Application Data
(60) Provisional application No. 61/070,516, filed on Mar. 24, 2008.

(51) Int. Cl. G09G 5/00

(52) U.S. Cl. 345/156

(57) ABSTRACT

A tracking device for determining position of at least one user relative to a video display has a wearable structure configured to be mounted on a human such a as a headset, eyeglasses or arm bands. The structure has two clusters of light emitting components which are spaced apart from one another. The LEDs in each cluster can emit different wavelengths of lines and be activated in sequences to identify not only the position of the user but also to distinguish one user from another user.

### CROSS-REFERENCE TO RELATED APPLICATIONS

Applicant claims the benefit of U.S. Provisional Application Ser. No. 61/070516 filed Mar. 24, 2008.

### BACKGROUND OF THE INVENTION

In the past, the term “Virtual Reality” has been used as a catch-all description for a number of technologies, products, and systems in the gaming, entertainment, training, and computing industries. It is often used to describe almost any simulated graphical environment, interaction device, or display technology. The term “immersion.” often used to describe any computer game in which the gamer is highly engrossed/immersed in playing the game (perhaps because of the complexity or rapid-reactions required of the game)—just as a reader can be engrossed/immersed in a book—even though the gamer can usually still see and hear real-world events not associated with the game.

True immersion in a game can be defined as the effect of convincing the gamer's mind to perceive the simulated game world as if it were real. As a result, the gamer's mind begins to perceive and interact with the virtual game environment as if it were the real world. This immersive effect allows the gamer to focus on the activity of game play, and not the mechanics of interacting with the game environment.

In recent years games and simulators have been developed in which game activity is displayed on a television, computer screen or other display and the scene on the display changes according to the movement of the user. Many games and simulators used joysticks to translate hand movement of the user to activity on the screen. Other games and simulators have used sensors attached to the user or player which translate movement of the user to activity on the screen. An example of the use of position sensors in video games can be found in Published United States Patent Application No. 2007/0132785, the content of which is herein expressly incorporated by reference.

One video game system that is currently popular is sold under the name Wii. This system contains a controller, also called a remote, similar in size to a television remote. The remote contains an infrared (IR) camera and is capable of receiving infrared light. The player holds the remote in his or her hand or attaches the controller to a leg or foot. Depending upon the game being played movement of the player's arm or leg is translated to display throwing, hitting or kicking a ball. The angle and speed of arm or leg movement determines the direction and speed of the ball in the game.

Head tracking has been used in simulators and some vehicles to enable the driver or operator to cause an action according to the movement and position of the user's head. In such systems the user wears a helmet, glasses or other device that has sensors or emitters which enable the system to track the position and movement of the head.

Head tracking can be used in combination with video games to give the user a sense of being part of the environment of the game. Indeed, a head tracking unit of the type here disclosed can enable the user to see a three dimensional display and have the feeling that he or she is in that virtual space. Such a system is shown in a video on the You-Tube website at http://www.youtube.com/watch?v=Jd3-eiid-Uw in a video titled “Head Tracking for Desktop Virtual Reality Displays using the Wii Remote.” In this System a Wii controller is placed below a video display screen on which the video game is played. The user is given a bar containing two spaced apart light emitting diodes (LEDs) which emit continuous infrared light Alternatively, the two spaced apart LEDs can be provided on a pair of glasses. One infrared LED is attached to each side of the frame. Both LEDs emit the same wavelength of light and are either on or off. These glasses or the bar with the LEDs are worn on the head of the user to permit head tracking by the Wii controller. The LEDs permit head tracking such that the scene on the screen responds to the position of the player. Head tracking can create the illusion that certain objects on the screen are behind or in front of the other objects. As the user moves to different positions relative to the screen and the Wii controller positioned below the screen, objects on the screen are shown in different views. The object gets larger on the screen as the user moves toward the screen. Other parts of an object or other objects appear on the screen as the user moves left or right. However, in this system head tracking only works for one person at a time playing the game.

The software used in this head tracking system is a custom C# DirectX program. Johnny Chung Lee, a PHD student at Carnegie Mellon University, recently made this program available as sample code for developers without support or documentation under the name WiiDesktopVR sample program. This program requires information about the display size and the spacing of the LEDs.

### SUMMARY OF THE INVENTION

We provide a head tracking system in which there is a cluster of LEDs one either side of the glasses or other device worn by the user. The cluster can be arranged in a pattern which may or may not be the same for each cluster.

The LEDs could emit different wavelengths of light. Such wavelengths need not be limited to the infrared spectrum, but could be visible light or any other wavelength that is detectable.

The LEDs can be activated in a manner to strobe or provide a distinct pattern of on and off pulses. The pulses may or may not be the same for all of the LEDs or cluster of LEDs.

Preferably the LEDs are controlled by a microprocessor which enables the LEDs to be strobed or activated in distinct patterns, or encryption methods. These patterns may be selected to correspond to a particular game or gaming device. These patterns may be digitally modulated to transmit digital data. Consequently, a particular set of head or body apparatus could be designed for use with only one type or brand of video game system. The patterns may be used to identify different body part locations.

Other aspects and advantages of our system will become apparent from a description of certain present preferred embodiments shown in the accompanying drawings.

### BRIEF DESCRIPTION OF THE FIGURES

FIG. 1 is a perspective view of a present preferred embodiment of our head tracking device for virtual reality displays.

FIG. 2 is a front view of the head tracking device shown in FIG. 1 being worn by a user.

FIG. 3 is a perspective view of a second present preferred embodiment of our head tracking device.

FIG. 4 is a perspective view of a third present preferred embodiment in the form of arm bands worn by the user.

FIG. 5 is a front view of a cluster of light emitting decoder that can be used in any embodiment of our head tracking system.

FIG. 6 is a front view of another cluster of light emitting diodes that can be used.

### DETAILED DESCRIPTION OF THE PREFERRED EMBODIMENTS

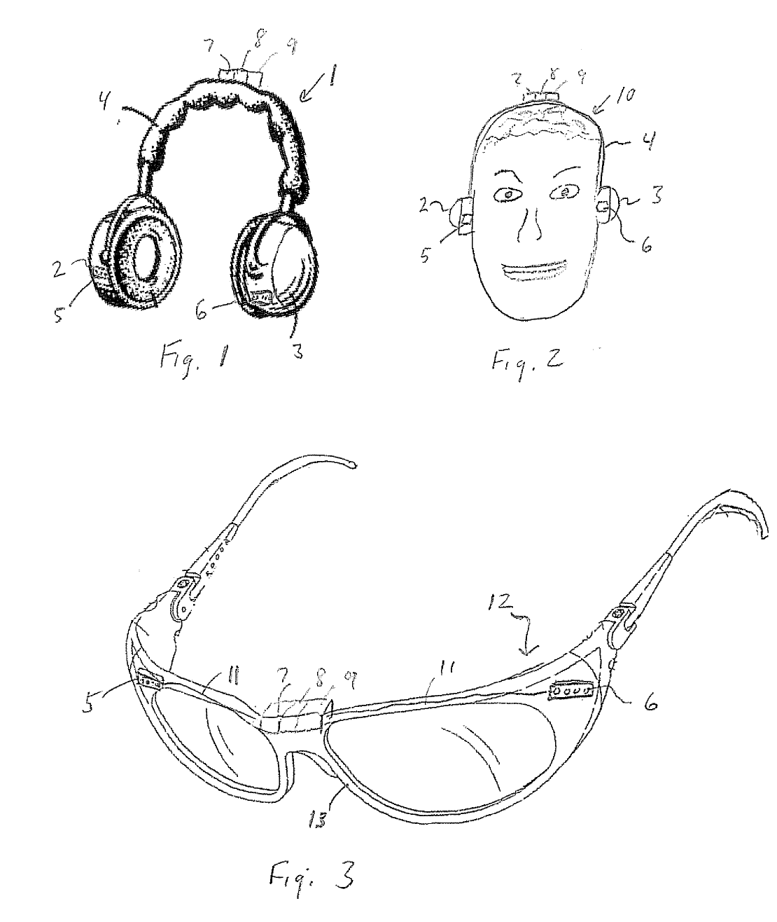

The first present preferred embodiment of our head tracking system is in the form of a headset 1 shown in FIGS. 1 and 2. The headset has a right portion 2 and a left portion 3 connected by a band 4. The left portion and right portion are configured to fit over the ears of a user 10. As shown in FIG. 2 a first cluster of light emitting diodes (LEDs) 5 is provided on the right portion 2. A second cluster of LEDs 6 is provided on the left portion 3. Other light emitting components such as reflectors could be used in place of the LEDs. These clusters are positioned so as to face forward when the headset is worn by a user as shown in FIG. 2. We also prefer to provide a battery 7, controller 8 and receiver 9 on the headset. In FIGS. 1 and 2 these components are shown as being attached to the headband 4. They could be provided on either the right portion 2 or left portion 3 of the headset.

A second present preferred embodiment shown in FIG. 3 is in the form of eyewear, such as eyeglasses 12, which can be worn by the user. The first cluster of LEDs 5 is provided on the right temple of the eyeglasses. The second cluster of LEDs 6 is provided on the left temple of the eyeglasses. Battery 7, controller 8 and receiver 9 can be provided on the frame 13 of the eyeglasses. These components are connected to the LED clusters 5, 6 by wires 11. The receiver may be RF, optical, or wired.

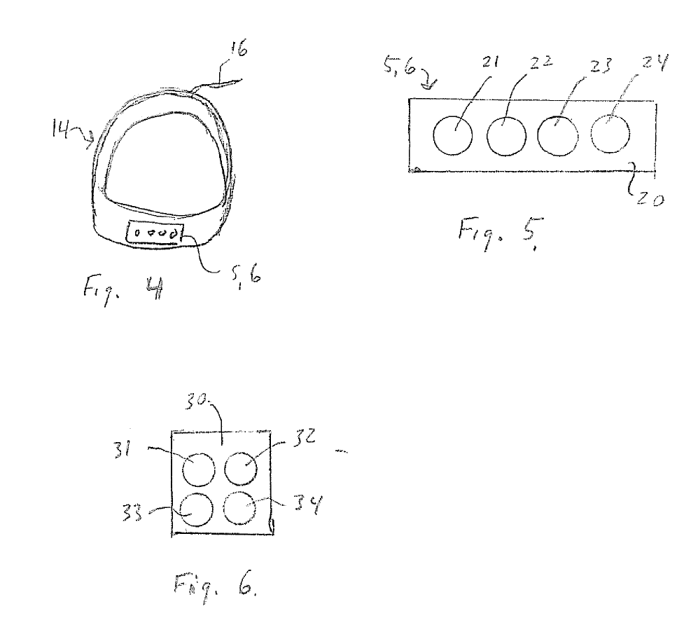

In a third present embodiment, each LED cluster 5, 6 is attached to a band 14 that may fit over an arm or leg of a user as shown in FIG. 4. Two of these bands would be connected together by wire or wireless connections 16. Because the two bands would be similar, only one is illustrated in FIG. 4. When the two bands are worn one cluster of LEDs would be at a first location and a second cluster of LEDs would be at a second location, spaced apart from the first location.

In the embodiments illustrated in FIGS. 1 through 4, the LEDs are shown positioned along a horizontal line. That arrangement is shown more clearly in FIG. 5. LEDs 21, 22, 23 and 24 are attached to a housing 20. These LEDs could be illuminated in any desired sequence or combination depending upon the desired response from the display.

The LEDs can be arranged in any desired configuration. In the embodiment of FIG. 6, LEDs 31, 32, 33 and 34 are mounted on housing 30 with each LED being in one of four quadrants. The LED clusters may have two or more LEDs and different clusters be used.

The receiver in the eyewear or other device worn by the user receives signals from a controller or other device associated with the video game system. The receiver could use IR from the light bar included in the Wii or other IR device, using some type of modulation or coding method. It could also use RF or other communication techniques. The receiver could be coupled to a microprocessor or controller that activates and controls the LEDs. This embodiment can be designed so that a distinct signal or pattern must be received to activate the head tracking unit. Indeed, different patterns or signals could be used to enable the head tracking unit to be used with different games, multiple players on the same game, or other activities. Consequently, one pattern would enable the user to play one game and a different pattern could be used to play another game. The patterns may also be used to set the level of difficulty of the game. Similarly, patterns emitted from the LEDs on the head tracking unit could be used in a similar way. The receiver and LEDs enable two way communications between the eyeglasses or other wearable device and the game controller. All of this would be determined by software in the microprocessor or microprocessors used to control the LEDs and the game controller. The patterns may be sent once, continuously or intermittently.

The microprocessor that is used as the controller can be very small and attached to the frame of the glasses or headband as shown in FIGS. 1 through 3.

One could provide diffusers or filters on the LEDs or LED clusters to create a desired effect.

While we have discussed using the LEDs on the headset, eyeglasses and band shown in FIGS. 1 through 4, other devices could be used. For example one could use an earmuff-like device in which the headband goes behind the head. One could also use head bands, caps, and other body attachment methods and attachment could be made to any selected locations on the user. Any device or structure that enables at least two spaced apart LED clusters to be attached to the user can be used.

A speaker and a microphone could be provided in the glasses, earmuffs or other wearable device. These components could be wired to the game console or be wireless.

The source of power for the LEDs in the glasses or other wearable device source could be a single use or rechargeable battery. If a rechargeable battery is used battery leads may be located to enable the glasses or other wearable device to be placed in a docking station for recharging when not in use. The eyeglasses or other wearable device could plug into the Wii remote held in the player's hand using the “nun chuck” port to provide power and or communications to/from the head set from the Wii remote and/or from the Wii, which talks to the remote via RF(Bluetooth). The power source could also be wireless, RF or inductive. The power can be switched on manually, by external trigger such as IR or RF, or by motion sensing trigger.

Because the use of the glasses or other wearable device containing the LEDs allows the system to know the position of the player or user in the room, one can design games or other displays that use that position information as part of the display or game. For example, the game may require the player to go to a position in the room and wait until the player does so. Then the user's position could be displayed on the screen or otherwise used. Indeed, the game software could utilize the position of the user in the room as a feature of the game. For example, the user may be directed by the game to move through a virtual room.

While the discussion has been focused on activity in a video game context, the system is not so limited. Being able to sense and track the position of the user in a room enables the system to be used to teach movement to the user. Those movements may constitute a dance step, a physical exercise or any other activity involving movement. The movement of the user could be displayed on the screen along with or in addition to the movement being taught.

Currently, the Wii system, as well as other video game consoles, is designed for network connection via the internet with other users of a comparable system. This enables two or more players in different locations to play the same game. The position tracking capability here disclosed enables the creation of video games in which the movement of two or more players becomes part of the game. Each player could be in a virtual room or other virtual location and the position of each player could be displayed on the screen. Even if a player's position is not displayed, that position could be tracked and be utilized in the game.

Our tracking device is not limited to the specific embodiments described and illustrated but may be variously embodied within the scope of the following claims.

We claim:

1. A head tracking device comprised of:
a headset having a body configured to be mounted on a human head and having a first location and a second location spaced apart form the first location;
a first plurality of light emitting components attached to the first location; and
a second plurality of light emitting components attached to the second location.

2. The head tracking device of claim 1 wherein the components in at least one of the first plurality of light emitting components and the second plurality of light emitting components emit different wavelengths of light.

3. The head tracking device of claim 1 wherein the headset is a set of eyewear.

4. The head tracking device of claim 3 wherein:
the eyewear has first and second spaced apart temples;
the first plurality of light emitting components is attached to the first temple; and
the second plurality of light emitting components is attached to the second temple.

5. The head tracking device of claim 1 wherein the headset is a comprised of:
a pair of ear attachments connected together by a band,
the first plurality of light emitting components is attached to one of the ear attachments; and
the second plurality of light emitting components attached the other ear attachment.

6. The head tracking device of claim 1 also comprising a power source connected to the first set of light emitting components and to the second set of light emitting components, the power source being attached to the headset.

7. The head tracking device of claim 6 wherein the power source is a battery.

8. The head tracking device of claim 6 wherein the power source is supplied via wire.

9. The head tracking device of claim 6 wherein the power source is remote from the headset and the headset further comprises a receiver attached to the headset and connected to the light emitting components such that power is transmitted wirelessly from the power source to the receiver.

10. The head tracking device of claim 1 also comprising a controller attached to the headset and connected to the light emitting components, the controller containing a program for illuminating at least one of the light emitting components.

11. The head tracking device of claim 10 wherein the controller contains a program for illuminating at least one light emitting component of the a first plurality of light emitting components and at least one light emitting component in the second plurality of components according to a selected pattern.

12. The head tracking device of claim 10 wherein the controller contains a program for illuminating via modulation at least one light emitting component of the first plurality of light emitting components to broadcast digital data.

13. The head tracking device of claim 10 wherein at least one light emitting component in the first plurality of light emitting components and at least one light emitting component in the second plurality of components are illuminated simultaneously.

14. The head tracking device of claim 1 also comprising a receiver attached to the headset and a controller connected to the receiver and the light emitting components.

15. The head tracking device of claim 14 wherein the light emitting components are activated and controlled by signals received by the receiver.

16. The head tracking device of claim 14 wherein the receiver is RF, optical, or wired.

17. The tracking device of claim 1 wherein the wearable structure is a pair of bands each band sized to fit at least one of an arm and a leg of a user.

18. The head tracking device of claim 1 wherein the light emitting components are light emitting diodes.

19. A tracking device for determining a position of at least one user relative to a video display comprised of:
a wearable structure configured to be mounted on a human and having a first location and a second location spaced apart form the first location,
a first plurality of light emitting components attached to the first location; and
a second plurality of components attached to the second location.

20. The tracking device of claim 19 wherein the wearable structure is a set of bands each bands sized to fit at least one of a head, an arm or a leg of a user having greater than two locations on the body.
